(19) United States
(12) Patent Application Publication
(10) Pub. No.: US 2009/0071242 A1
(43) Pub. Date: Mar. 19, 2009

(54) DISPENSING SYSTEM AND JUDGING METHOD OF DISCHARGE CONDITION THEREOF

(76) Inventor: Akira HIGUCHI, Fukuoka (JP)

Correspondence Address: WENDEROTH, LIND & PONACK L.L.P., 2033 K. STREET, NW, SUITE 800, WASHINGTON, DC, 20006, US

(21) Appl. No.: 12/211,967

(22) Filed: Sep. 17, 2008

(30) Foreign Application Priority Data
Sep. 19, 2007 (JP) 2007-241870

(51) Int. Cl. G01F 7/00

(52) U.S. Cl. 73/196; 73/1.02

(57) ABSTRACT

When a discharge trouble such as clogging has occurred in a plurality of branch tubes branched from a flow tube coupled with a pressure vessel, it is displayed immediately as a flow rate variation in the flow tube. A Judgment section of a dispensing system, therefore, finds the discharge trouble in the branch tubes immediately based on a flow rate detected by a flow-rate detector provided on the flow tube. Moreover, the judgment section identifies the branch tubes where the discharge trouble has occurred based on the respective flow rates of the branch tubes opened individually or opened in a predetermined combination.

### BACKGROUND OF THE INVENTION

1. Field of the Invention

The present invention relates to a dispensing system to dispense liquid to a plurality of wells, and to a judging method of discharge condition of the system.

2. Background Art

The dispensing system is used to dispense liquid to a plurality of wells. In an ordinary dispensing system, a flow path extending from a liquid supply source (vessel) is branched into a plurality of branch paths along the way. Liquid pumped from the liquid supply source and distributed into individual branch paths is discharged to wells from discharge heads provided at the end of each path.

Troubles in flowing condition such as clogging in the flow path can be judged based on pressure variations in the flow path. Clogging or the like occurred in any of the branch paths, however, causes only a little absolute value in the pressure variation. Moreover, response time delays due to the location of pressure sensor in some case. Therefore, it is hard to find immediately the occurrence of clogging in any of branch paths.

### SUMMARY OF THE INVENTION

One phase of the dispensing system disclosed in the present invention includes following items: a first flow path, a flow-rate detector, a branch section, N pieces of second flow paths, and N pieces of valves. The first flow path is coupled with a liquid supply source. The flow-rate detector is provided on the first flow path. The branch section branches the first flow path into N pieces of the second flow paths. The second flow paths branched in the branch section have discharge heads at the ends. Each valve is capable of opening and closing one of the second flow paths, respectively. The dispensing system of the present invention further includes following items: a first flow-rate calculator, a first judgment section, a second flow-rate calculator, and a second judgment section. The first flow-rate calculator detects liquid flow rates by the flow-rate detector under the condition that all the valves are open. The first judgment section judges a discharge condition by comparing the liquid flow rate detected by the first flow rate detector with a total liquid flow rate to be discharged from all the discharge heads. N pieces of the second flow paths are divided into N pieces of group each consisting of a same number of at least one and at most (N−1) pieces of the second flow paths. The second flow-rate calculator detects respective flow rates of liquid by the flow-rate detector under the condition that valves corresponding to the second flow paths included in each group are open. The second judgment section identifies any of the second flow paths that are clogged or have possibility of being clogged based on the respective flow rates of the groups of the second flow paths detected by the second flow-rate calculator.

Another phase of the dispensing system disclosed in the present invention includes following items other than the first flow path, the flow-rate detector, the branch section, N pieces of the second flow paths, and N pieces of the valves which are described: one of a counter and a timer, a flow detecting section, and a judgment section. The counter counts numbers of time for dispensing operation. The timer measures an operation period of time for dispensing. N pieces of the second flow paths are divided into N pieces of group each consisting of a same number of at least one and at most (N−1) pieces of the second flow paths. When the counter shows more than a predetermined number of times for dispensing or the timer shows a longer period of time than a predetermined period of time for dispensing, the flow-rate calculator detects flow rates of liquid by the flow-rate detector under the condition that valves corresponding to the second flow paths included in each group are open. The judgment section identifies any of the second flow paths that are clogged or have possibility of being clogged based on the respective flow rates of the groups of the second flow paths detected by the flow-rate calculator.

### BRIEF DESCRIPTION OF THE DRAWINGS

FIG. 1 shows an overall schematic view of the dispensing system according to an exemplary embodiment of the present invention.

FIG. 2 shows a control configuration diagram of the dispensing system shown in FIG. 1.

FIG. 3 shows a flowchart of a normal operation in the dispensing system shown in FIG. 1.

FIG. 4 shows a flowchart of a judging operation for discharge condition in the dispensing system shown in FIG. 1.

FIG. 5 shows a flowchart of a verification operation in the dispensing system shown in FIG. 1.

FIGS. 6 and 7 show tables for the verification operation in the dispensing system shown in FIG. 1.

FIG. 8 shows a flowchart of a clogging detection operation in the dispensing system shown in FIG. 1.

FIG. 9 shows another example of a flow-rate detector in the dispensing system shown in FIG. 1.

### DETAILED DESCRIPTION OF THE INVENTION

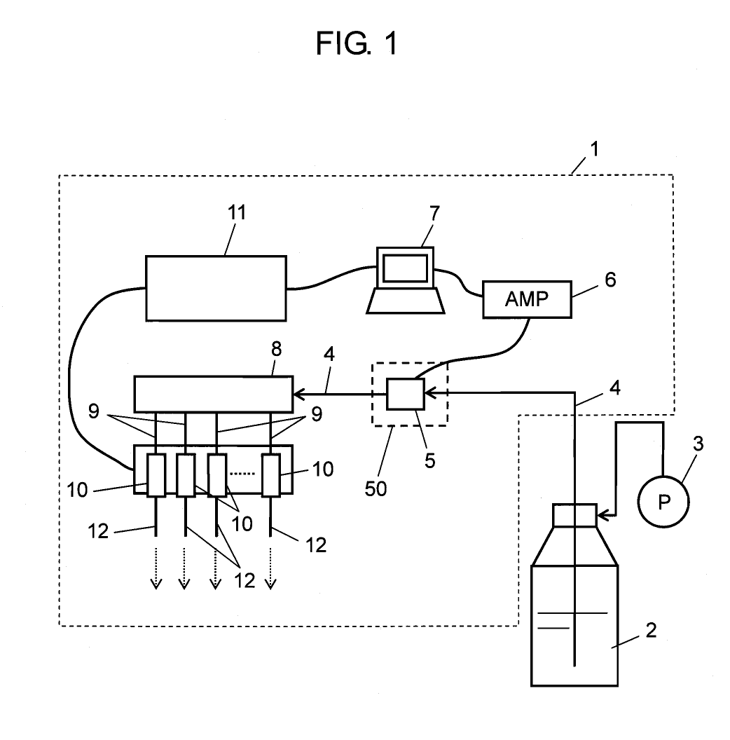

FIG. 1 shows an overall schematic view of a dispensing system according to an exemplary embodiment of the present invention. Dispensing system 1 includes flow tube 4, flow-rate detector 50, manifold 8, branch tubes 9, valves 10, nozzles 12, valve controller 11, computer 7, and amplifier 6.

Flow tube 4 as a first flow path is coupled with pressure vessel 2. Pressure vessel 2 stores a liquid to be dispensed by dispensing system 1, and functions to pump the liquid to flow tube 4 by pressurizing inside of pressure vessel 2 using pressure pump 3. That is, pressure vessel 2 and pressure pump 3 function as a liquid supply source in dispensing system 1.

Flow-rate detector 50 including flow-rate sensor 5 is provided on flow tube 4. Manifold 8 as a branch section branches flow tube 4 into a plurality of second flow paths. Namely, manifold 8 functions to distribute the liquid pumped through flow tube 4 into branch tubes 9. Branch tubes 9 as the second flow paths are branched from manifold 8 and have nozzles 12 on respective ends to discharge the liquid. Each branch tube 9 is provided with an openable/closable valve 10 individually. That is, valve 10 is capable of opening and closing branch tube 9.

Computer 7 detects the liquid flow rate by processing electric signals sent from flow-rate sensor 5 via amplifier 6. Computer 7 also sends control commands to valve controller 11 to open/close valves 10 individually.

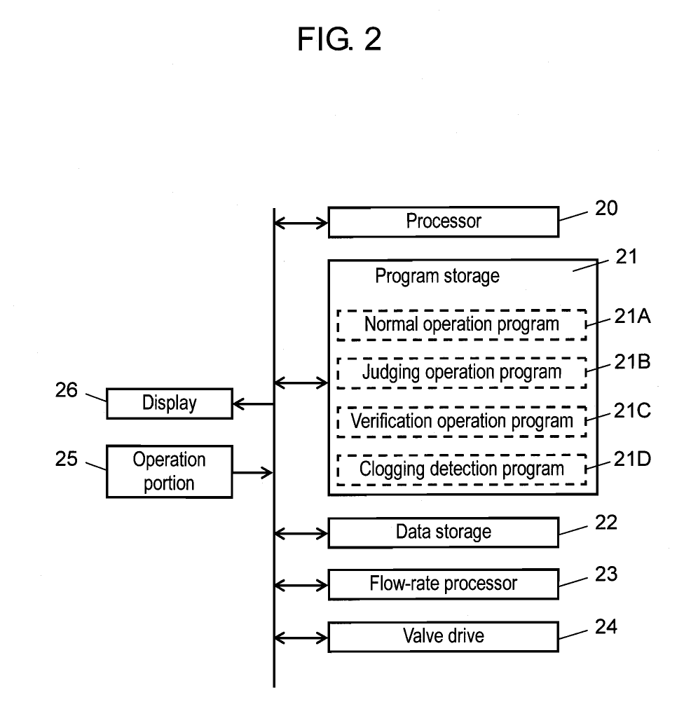

The configuration of computer 7 is described next with reference to FIG. 2. FIG. 2 shows a control configuration diagram of dispensing system 1 shown in FIG. 1. Processor 20 controls the operations of dispensing system 1 in accordance with programs 21A to 21D stored in program storage 21. Program storage 21 stores normal operation program 21A, judging operation program 21B, verification operation program 21C, and clogging detection program 21D. In these programs, normal operation program 21A is the host program to control dispensing operations for dispensing system 1. Meanwhile, judging operation program 21B, verification operation program 21C, and clogging detection program 21D are all sub-programs that start running along with normal operation program 21A. Data storage 22 stores control parameters such as tolerance of liquid flow rate or the like for use in programs 21A to 21D.

Flow-rate processor 23 reads voltages output from flow-rate sensor 5 via amplifier 6, and then outputs flow rate values in response to the voltage values. Valve drive 24 controls opening/closing of valves 10 in accordance with programs 21A to 21D, respectively. Operating portion 25 and display 26 are interfaces to exchange information between an operator and dispensing system 1. The operator starts and operates dispensing system 1, and inputs data through operating portion 25, and receives information on operational condition of dispensing system 1 through display 26.

In the above configuration, processor 20 functions as a first judgment section, which judges the liquid discharge condition by comparing flow rate detected by flow-rate processor 23 with a setting flow rate conducted from total liquid flow rate to be discharged from all nozzles 12. Additionally, processor 20 also functions as a second judgment section, which identifies any of branch tubes 9 that are clogged or have possibility of being clogged based on the respective flow rates of branch tubes 9 detected by flow-rate processor 23. Flow-rate processor 23 also functions as a flow-rate calculator to detect a liquid flow rate by flow rate detector 50.

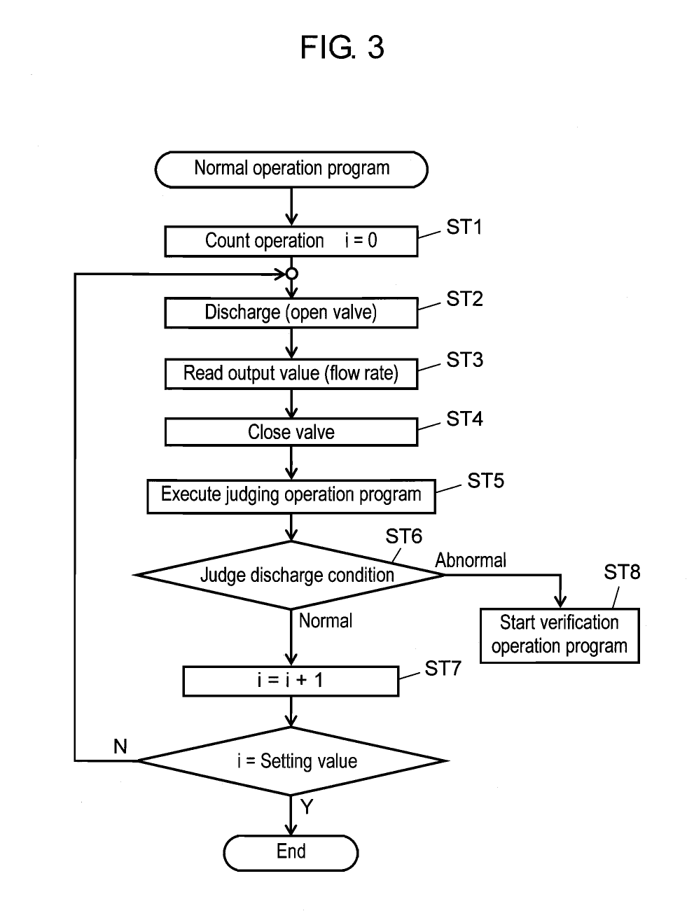

The dispensing operations of dispensing system 1 are described next with reference to FIGS. 3 to 8. The normal operation of dispensing system 1 is described first. FIG. 3 shows a flowchart of the normal operation of dispensing system 1.

Dispensing system 1 executes normal operation program 21A in accordance with the flowchart shown in FIG. 3. When normal operation program 21A is launched, firstly operation count (i) (number of dispensing operation) is set 0 (ST 1). Then, valve drive 24 allows valve controller 11 to open all valves 10 to discharge liquid from all nozzles 12 (ST 2). At this time, flow-rate processor 23 reads output from flow-rate sensor 5 as a flow rate of the liquid pumped through flow tube 4 (ST 3). Flow-rate processor 23, therefore, functions as a first flow-rate calculator at this time to detect liquid flow rate by flow rate detector 50 under the condition that all valves 10 are open.

Valve drive 24 allows valve controller 11 to close all valves 10 after a predetermined time has passed since valves 10 have opened (ST 4). Judging operation program 21B is launched next (ST 5), and the condition of liquid discharge is judged (ST 6).

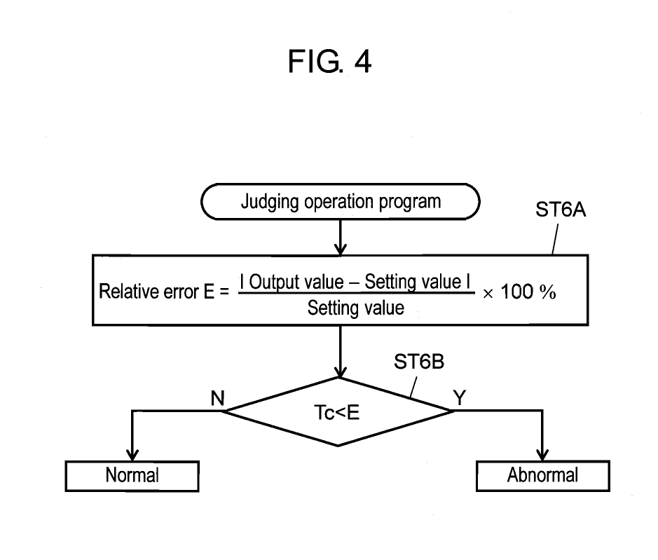

Now, the judging operation for discharge condition is described with reference to FIG. 4. FIG. 4 shows a flowchart of the judging operation for discharge condition in dispensing system 1. Dispensing system 1 executes judging operation program 21B in accordance with the flowchart shown in FIG. 4.

When judging operation program 21B is launched, processor 20 calculates relative error E from a setting value and an output value which is a flow rate value read in ST 3 (ST 6A). The setting value is a setting flow rate conducted from total amount of the liquid to be discharged from all nozzles 12 in a single discharge, assuming that all branch tubes 9 are in a normal condition without any clogging. Comparing relative error E with tolerance Tc, processor 20 judges whether the discharge condition is normal or abnormal (ST 6B).

When relative error E is equal or smaller than tolerance Tc, processor 20 judges that the total amount of the liquid pumped through flow tube 4 to be discharged from nozzles 12 is equal or almost equal to the setting flow rate. Namely, the judgment is that there is no discharge trouble such as clogging in all branch tubes 9. The discharge condition of the liquid is judged to be normal in this case.

On the other hand, when relative error E is more than tolerance Tc, processor 20 judges that the total amount of the liquid pumped through flow tube 4 to discharge from all nozzles 12 is less than the setting flow rate by more than a certain value. From this, processor 20 judges that discharge troubles such as clogging have occurred or have possibly occurred in some of branch tubes 9. Therefore, the discharge condition of the liquid is judged to be abnormal in this case.

When the discharge condition is judged to be normal, processor 20 counts up operation count (i) as shown in FIG. 3 (ST 7). The dispensing operations are continued if the operation count (i) after counting up doesn't reach a setting value previously stored in data storage 22. At a time when the operation count (i) reaches the setting value, normal operation program 21A exits to stop the dispensing operations. Meanwhile, verification operation program 21C is launched if the discharge condition is judged to be abnormal (ST 8).

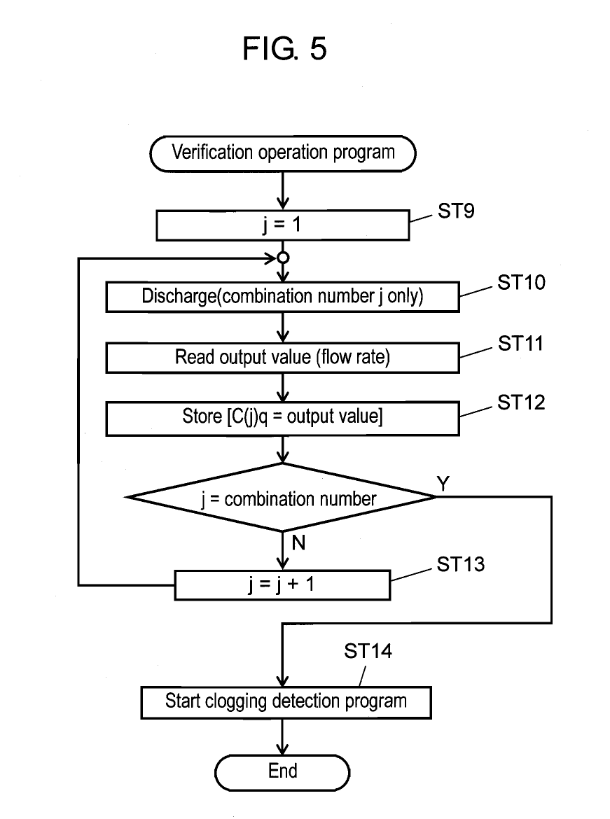

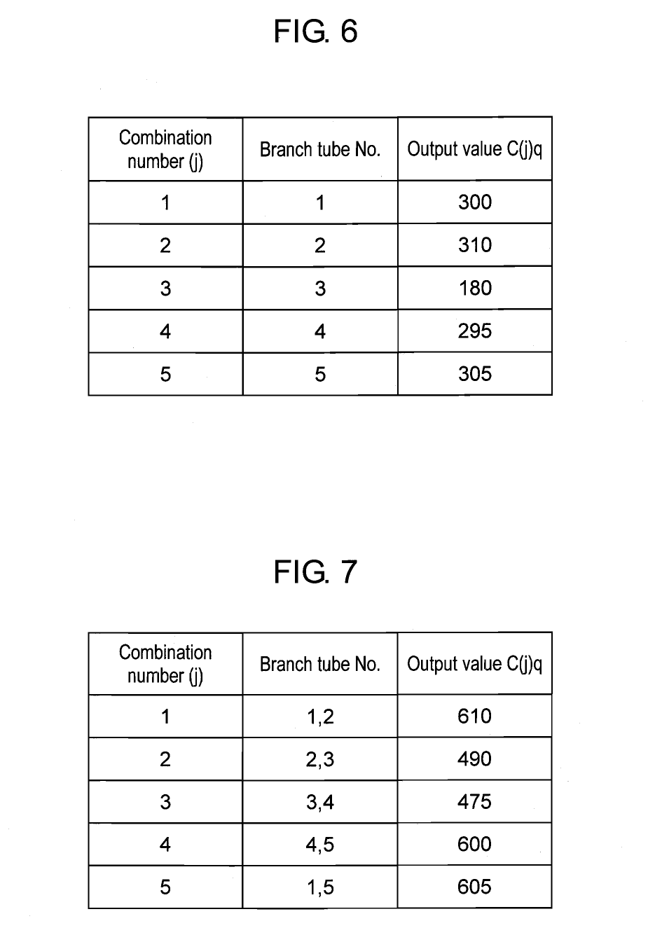

The verification operation is described next with reference to FIGS. 5 to 7. FIG. 5 shows a flowchart of the verification operation in dispensing system 1. FIG. 6 and 7 show tables for the verification operation in dispensing system 1. Dispensing system 1 executes verification operation program 21C in accordance with the flowchart shown in FIG. 5.

This program employs a combination table in which each different branch tube 9 is allocated in every combination number (j) as shown in FIG. 6. The table is stored in data storage 22 previously. Data storage 22 stores every combination number (j) being associated with each output value (C(j)q). When verification operation program 21C is launched, processor 20 first selects combination number (j=1) (ST 9). Subsequently, only one of valves 10 provided on branch tube 9 corresponding to the combination number is allowed open, with all the other of valves 10 closed.

Next, computer 7 starts driving pressure pump 3 to discharge the liquid from nozzle 12 of valve 10, which is the only one allowed open (ST 10). At this time, flow-rate processor 23 reads the flow rate of the liquid pumped through flow tube 4 (ST 11). Data storage 22 stores the flow rate as an output value (C(1)q) (ST 12).

By the operations so far, the verification operations on combination number (j=1) are over, and processor 20 next executes the similar verification operations on combination number (j=2) (ST 13). Processor 20 executes the verification operations changing one of branch tubes 9 with corresponding valve 10 allowed open. Through the series of operations, data storage 22 stores output value (C(1)q, C(2)q, - - - ) on every combination number (j=1, 2, - - - ). On this occasion, flow-rate processor 23 functions as a second flow-rate calculator, which detects respective flow rates of the liquid by flow-rate detector 50 when each of valves 10 is open. After the operations finishes, processor 20 launches clogging detection program 21D (ST 14).

Meanwhile, the form of combination table is not limited only to the table in which each different branch tube 9 is allocated one by one in every combination number (j) shown in FIG. 6. A table may be allowed in which each different combination of two of branch tubes 9 is allocated in every combination number (j) as shown in FIG. 7. The number of combination is not limited only to two. When the total number of branch tubes 9 is N, the combination number for branch tubes 9 can be at least 2 and at most (N−1). In this case, processor 20 executes the verification operations changing every combination number (j) of a same number of valves 10 allowed open.

As described above, a plurality of valves 10 may be allowed open at the same time. When a liquid flow rate in one of branch tubes 9 is excessively little, it is hard for flow-rate sensor 5 provided on flow tube 4 to read the flow rate accurately. In such a case, it is effective to increase the flow rate to a larger amount so that flow-rate sensor 5 can read it by discharging from a plurality of nozzles 12 at the same time.

When the total number of branch tubes 9 is N, branch tubes 9 are divided into N pieces of groups each consisting of at least one and at most (N−1) of branch tubes 9, by adding the case shown in FIG. 6 in which each valve 10 is opened individually. Then valves 10 corresponding to branch tubes 9 included in each group are opened. Meanwhile, when each group includes more than two of branch tubes 9, numbers of brand tubes 9 are allocated overlapping to combination number (j) as shown in FIG. 7.

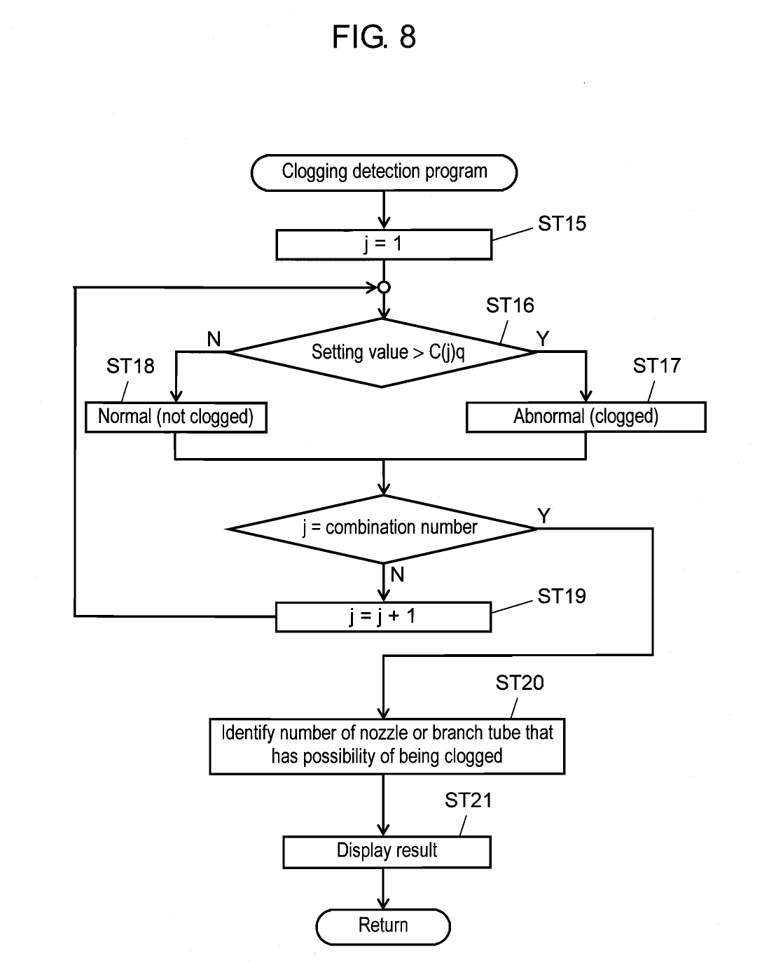

The clogging detection operations are described next with reference to FIG. 8. FIG. 8 shows a flowchart of the clogging detection operation in dispensing system 1. Dispensing system 1 executes clogging detection program 21D in accordance with the flowchart shown in FIG. 8.

This program employs output values (C(1)q, C(2)q, - - - ) stored in data storage 22 by verification operation program 21C. When clogging detection program 21D starts running, processor 20 first selects the combination number (j=1) (ST 15), and then compares the corresponding output value (C(1)q) with a setting value previously stored in data storage 22 (ST 16). The setting value is a setting flow rate of the liquid to be discharged from one of nozzles 12, assuming that branch tube 9 is in a normal condition without any clogging.

A case of output value (C(1)q) lower than the setting value is judged abnormal (ST 17), and a case other than this is judged normal (ST 18). In a similar way on all combination numbers (j=2 - - - ) following the combination number (j=1), output values (C(2)q, - - - ) are compared with the setting value (ST 19). Branch tubes 9 (or nozzles 12) corresponding to the combination numbers (j) that are judged abnormal in the discharge conditions are identified (ST 20), and the result is shown in display 26 (ST 26). Clogging detection program 21D finishes now and verification operation program 21C as an upper program also finishes.

In the combination table shown in FIG. 6, when the setting value is 290, for instance, output value 180 for the combination number (j=3) is lower than the setting value. Therefore, the discharge condition of branch tube 9 allocated to the combination number (j=3) is displayed as abnormal. According to the indicated result, operators will investigate branch tube 9 including nozzles 12 in which clogging has occurred or there is a possibility of clogging. Adjustments or maintenances or some following-up such as replacements of branch tubes 9 or nozzles 12 would be necessary by the extent of the discharge trouble. After the following-up, the operator performs a verification operation again on target branch tube 9 to confirm that the discharge is in normal condition In the above description, display 26 shows an identified branch tube 9 whose output value (C(j)q) is judged abnormal. Other than this, display 26 can be set to show the output values (C(1)q, C(2)q, - - - ) for all combination numbers (j=1, 2 - - - ). For instance, the operator himself/herself can identify branch tubes 9 in which clogging has occurred or there is a possibility of clogging by displaying the combination table shown in FIG. 6 based on the output values (C(1)q, C(2)q, - - - ). In this case, operator doesn't compare each output values (C(1)q, C(2)q, - - - ) with the setting value. Branch tube 9 allocated to the combination number (j=3) that shows a relatively small output value 180 is identified as branch tube 9 that is clogged or has possibility of being clogged.

FIG. 7 shows a case using another combination table in which each different combination of two of branch tubes 9 is allocated in every combination number (j). In this case, the setting value is provided assuming a liquid flow rate to be discharged from two of nozzles 12 in a normal condition in which branch tubes 9 are without any clogging. The output value (C(1)q) corresponding to the combination number (j=1) is compared with the setting value in ST 16. When the setting value is 580, for example, as output values 490 and 475 for combination number (j=2, 3) are below the setting value, branch tube 9 allocated to both combination numbers (j=2, 3) is displayed to be abnormal in discharge condition. Thus, processor 20 as the second judgment section identifies the second flow path in which clogging has occurred or there is a possibility of clogging based on the respective flow rates of the groups of branch tubes 9 detected by flow-rate processor 23 as the second flow-rate calculator.

In normal operation program 21A, steps from reading of flow rate (ST 3) to judging operation of discharge condition (ST 6) can be omitted. In this case, when number of times of the dispensing operation is over a predetermined number of times or the operation period of time is over a predetermined period of time, verification operation program 21C is launched. The operation control can be performed also in this way. In this case, processor 20 functions as a counter to count operation count (i) (dispensing number of times) as described in ST 7. Alternatively, processor 20 functions as a timer to measure the dispensing operation period of time.

In some cases of the shape and size of branch tube 9 or nozzle 12, or the kind of the liquid, dispensing operation may be carried out under the condition less likely to occur the discharge trouble of clogging or the like. Under such conditions, judging the discharge condition in every dispensing operation is not preferable from the standpoint of production efficacy. In such a case, the discharge condition may not be judged in every dispensing operation but may be judged only when the dispensing operation number of times is over a predetermined number of times or the operation period of time is over a predetermined period of time.

Therefore, when a more precise understanding is necessary on discharge conditions, the discharge conditions should be judged in every dispensing operation, and contrarily this should be omitted when production efficacy is emphasized. Thus, dispensing system 1 can realize suitable dispensing operations for production conditions.

As described above, in the case of discharge troubles such as clogging occurred in a plurality of branch tubes 9 branched from flow tube 4 coupled with the liquid supply source, the variation of flow rate in flow tube 4 is shown immediately. Noticing the occurrence, any discharge trouble occurred in branch tubes 9 can be found immediately based on a flow rate detected by a single flow-rate detector 50 provided on flow tube 4. Additionally, discharge troubles in specific branch tubes 9 can also be found based on respective flow rates of branch tubes 9 opened individually or in a predetermined combination.

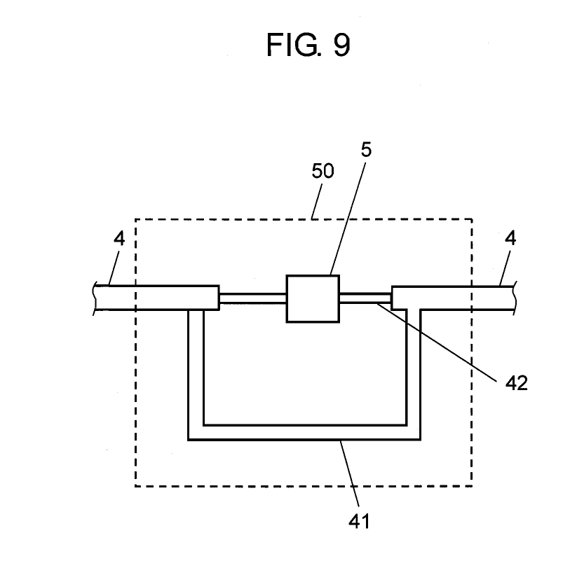

In this embodiment, an example is described in which flow-rate sensor 5 is mounted on flow tube 4 directly to form flow-rate detector 50, but the configuration is not limited to this. Another configuration is available in which measuring path 42 and bypass 41 are provided along the way of flow tube 4 to mount flow-rate sensor 5 on measuring path 42 as shown in FIG. 9. The flow rate of the liquid through measuring path 42 is set so as to be lower than that through bypass 41. For flow-rate sensor 5, therefore, such type of sensor can be adopted which has high resolution though narrow in detection range for flow rate.

As described above, the dispensing system of the present invention includes a first flow path coupled with one liquid supply source, and second flow paths branched from the first flow path. In the case of discharge troubles such as clogging occurred in any of the second flow paths, the discharge troubles in the second flow paths can be found immediately based on a flow rate detected by a flow-rate sensor provided on the first flow path. The dispensing system is useful especially in the field of dispensing liquid such as chemical solution or culture solution into wells continuously.

What is claimed is:

1. A dispensing system comprising:
a first flow path coupled with a liquid supply source;
a flow-rate detector provided on the first flow path;
a branch section branching the first flow path;
N pieces of second flow paths, branched from the first flow path in the branch section, each of the second flow paths having a discharge head for a liquid at an end thereof;
N pieces of valves capable of opening and closing the N pieces of second flow paths individually;
a first flow-rate calculator configured to detect a flow rate of the liquid by the flow-rate detector under a condition in which all the valves are open;
a first judgment section configured to judge a discharge condition of the liquid by comparing the flow rate detected by the flow-rate detector with a setting flow rate conducted from a total flow rate to be discharged from all the discharge heads;
a second flow-rate calculator configured to detect respective flow rates of the liquid by the flow-rate detector under conditions that, when the N pieces of the second flow paths are divided into N pieces of groups each having a same number of at least one and at most (N−1) pieces of the second flow paths, one or more of the valves corresponding to the second flow paths included in each of the groups are open; and
a second judgment section configured to identify any of the second flow paths that are clogged or have possibility of being clogged based on the respective flow rates of the groups of the second flow paths detected by the second flow-rate calculator.

2. A judging method for a discharging condition in a dispensing system, the dispensing system comprising a first flow path coupled with a liquid supply source, a branch section branching the first flow path, N pieces of second flow paths, branched from the first flow path in the branch section, each of the second flow paths having a discharge head for a liquid at an end thereof; and N pieces of valves capable of opening and closing the N pieces of second flow paths individually; the judging method comprising:
detecting a flow rate of the liquid under a condition in which all the valves are open;
judging a discharge condition by comparing a detected flow rate with a setting flow rate conducted from a total flow rate to be discharged from all the discharge heads;
detecting respective flow rates of the liquid under conditions that, when the N pieces of the second flow paths are divided into N pieces of groups each having a same number of at least one and at most (N−1) pieces of the second flow paths, one or more of the valves corresponding to the second flow paths included in each of the groups are open; and
identifying any of the second flow paths that are clogged or have possibility of being clogged based on the respective detected flow rates of the each group of the second flow paths.

3. A dispensing system comprising:
a first flow path coupled with a liquid supply source;
a flow-rate detector provided on the first flow path;
a branch section branching the first flow path;
N pieces of second flow paths, branched from the first flow path in the branch section, each of the second flow paths having a discharge head for a liquid at an end thereof;
N pieces of valves capable of opening and closing the N pieces of second flow paths individually;
one of a counter and a timer, the counter configured to count a number of times for dispensing operation and the timer configured to measure an operation period of time for dispensing;
a flow-rate calculator configured to detect respective flow rates of the liquid by the flow-rate detector under conditions that, when the N pieces of the second flow paths are divided into N pieces of groups each having a same number of at least one and at most (N−1) pieces of the second flow paths, one or more of the valves corresponding to the second flow paths included in each of the groups are open, at a time that the counter shows more than a predetermined number of times of dispensing operation or the timer shows a longer period of time than a predetermined period of time for dispensing; and
a judgment section configured to identify any of the second flow paths that are clogged or have possibility of being clogged based on the respective flow rates of the groups of the second flow paths detected by the flow-rate calculator.

4. A judging method for a discharging condition in a dispensing system, the dispensing system comprising a first flow path coupled with a liquid supply source, a branch section branching the first flow path, N pieces of second flow paths, branched from the first flow path in the branch section, each of the second flow paths having a discharge head for a liquid at an end thereof; and N pieces of valves capable of opening and closing the N pieces of second flow paths individually; the judging method comprising:
detecting respective flow rates of the liquid by the flow-rate detector under conditions that, when the N pieces of the second flow paths are divided into N pieces of groups each having a same number of at least one and at most (N−1) pieces of the second flow paths, one or more of the valves corresponding to the second flow paths included in each of the groups are open, at a time that the counter shows more than a predetermined number of times of dispensing operation or the timer shows a longer period of time than a predetermined period of time for dispensing; and
identifying any of the second flow paths that are clogged or have possibility of being clogged based on the detected respective flow rates of the groups of the second flow path.
